(19) United States
(12) Patent Application Publication
(10) Pub. No.: US 2008/0181411 A1
(43) Pub. Date: Jul. 31, 2008

(54) METHOD AND SYSTEM FOR PROTECTING SIGNALING INFORMATION

(76) Inventors: Karl Norrman, Stockholm (SE); Mats Näslund, Bromma (SE)

Correspondence Address: ERICSSON INC., 6300 LEGACY DRIVE, M/S EVR 1-C-11, PLANO, TX, 75024, US

(21) Appl. No.: 11/956,815

(22) Filed: Dec. 14, 2007

Related U.S. Application Data
(60) Provisional application No. 60/886,694, filed on Jan. 26, 2007.

(51) Int. Cl. H04L 9/08

(52) U.S. Cl. 380/278

(57) ABSTRACT

A path switch message in a mobile radio access network is protected as the message is sent over a user plane interface that may be insecure (e.g. lacks integrity and/or confidentiality protection). According to the invention a UE provides an AP with a fresh integrity key over an already existing and secure RAN channel enabling AP to use the integrity key to integrity protect information sent to a UPN. Specifically, UE derives locally at least a user plane key K1. The key derivation is done at authentication e.g. when performing an AKA procedure. On the network side CPN derives the same key K1 for delivery to UPN. At handover, the UE generates a fresh integrity key K3 by applying a Key Derivation Function (KDF) with at least the UP key K1 and a nonce, e.g. a sequence number.

### CROSS-REFERENCE TO RELATED APPLICATIONS

This application which claims the benefit of U.S. Provisional Application No. 60/886,694, filed Jan. 26, 2007, the disclosure of which is incorporated herein by reference.

### STATEMENT REGARDING FEDERALLY SPONSORED RESEARCH OR DEVELOPMENT

NOT APPLICABLE

### REFERENCE TO SEQUENCE LISTING, A TABLE. OR A COMPUTER PROGRAM LISTING COMPACT DISC APPENDIX

NOT APPLICABLE

### BACKGROUND OF THE INVENTION

The present invention relates to mobility in Radio Access Networks. More particularly, and not by way of limitation, the present invention is directed to a system and method for providing additional protection of mobility signaling messages in a wireless network.

3GPP is currently standardizing EPS; the Evolved Packet System. the recently renamed System Architecture Evolution (SAE). 3GPP is also developing standards and definition of a new Orthogonal Frequency Division Multiplexing Access (air interface) through the Long Term Evolution program. This new OFDMA based air interface is also referred to as the E-UTRAN, the Evolved UMTS Terrestrial Radio Access Network (RAN)[1]. LTE and EUTRAN may both be used interchangeably hereinafter. This RAN will support higher bandwidth, simplified mobility procedures, etc. For this reason, totally new, optimized signaling flows will be used, raising some problems from a security point of view.

In EUTRAN, a base station (called eNB), has two interfaces to the Evolved Packet Core (EPC) network. One for the control plane called S1-C, which is connected to a Mobility Management Entity (MME), and one for the user plane called S1-U, which is connected to a Serving Gateway (SGW). This is depicted in FIG. 1. Not shown in FIG. 1 is a logical interface between the SGW and the MME.

It can be observed that, roughly speaking, the MME contains Control Plane (CP) functions of the current SGSN, and the SGW contains User Plane (UP) functions which today reside in SGSN and RNC.

The MME and SGW keep track of the IP address and port number to which it via the eNB, sends data that is intended for a particular User Equipment (UE), i.e. mobile terminal. If the UE performs an inter-eNB handover, due to mobility the MME and SGW need to be informed about the IP address and port of the new (target) eNB, so that they can re-direct the data for the UE to the correct location.

During the standardization process, it has been decided that the S1-C interface should be both integrity protected and confidentiality protected, since encryption keys and other important data will traverse it. The S1-U interface at the time was not considered important enough, so the S1-U interface has no integrity or confidentiality protection at all.

In the EPS, a UE can be in idle mode (silently moving in the network to save battery power) or active mode (moving while transmitting data). In both modes, the UE continuously makes measurements of the signal strength of the surrounding eNB nodes.

In idle mode, the UE just “camps” on a preferred eNB without notifying the network. In active mode, however, the UE reports the measurements to the eNB that it is currently associated with. If the eNB decides that it would be better to hand over the UE to another eNB, e.g., because it has better signaling strength than the current eNB, it initiates a procedure as that depicted in FIG. 2. The handover progresses entirely within the RAN and is completely transparent to the core network up until it is completed from the RAN point of view. When this happens, the RAN informs the core network about the new location of the UE.

Earlier, it was proposed in 3GPP RAN3 that, upon completion of handover of a UE in active mode, the target eNB shall send the IP address and port number to the UP node (at the time referred to as “User Plane Entity”, UPE) over the S1-U interface in a “path switch” message for future communication with the UE. The message contains the IP address and port number of the target eNB and is delivered to the UPE in message number 7b in FIG. 2 (this former UPE node would in the current, modified architecture roughly correspond to the SGW node.)

There is thus a “peculiarity” with such a path switch message: while the path switch message is logically a control plane message it is actually sent to a user plane entity. (the UPE). The fact that a control plane message is sent over a user plane “channel”, i.e., a channel which lacks protection, is disadvantageous from a security point of view. There are three main attacks possible against the above signaling approach.

Assuming no protection is applied in addition to the mechanisms described above for S1-C, the Radio Resource Control (RRC) traffic between the UE, the eNB is integrity and confidentiality protected and the user plane traffic is confidentiality protected between the UE and the UPE; an attack can still be made against the handover procedure.

An attacker who is able to modify (or inject) packets on S1-U towards EPC (i.e. located either between an eNB and the EPC, or “inside” an eNB), can change the path switch message, in order to redirect a user's traffic to an address of his choice. Since the EPC is not aware that an eNB-handover is in progress until receiving the path switch message, this attack can be done at any point in time and not necessarily during a handover procedure. Accordingly, user traffic can be diverted at any moment in time.

There was an earlier proposal to solve the problem described in S3-060455 [2] comprising generation of a “token” in the UE, based on the UP ciphering key, the identities of the involved eNB nodes, and a sequence number for replay protection, i.e. the UE increases the sequence number (SEQ) to a value not already used. Thus, UE creates a path_switch_token of the form:

path_switch_token=f(CkUP, SEQ, source_eNB_ID, target_eNB_ID)∥SEQ,

for some suitable cryptographic function f, e.g. HMAC.

UE delivers the token to the target eNB. e.g., in message 6 (Handover confirm) in FIG. 2. The eNB forwards the token completed with address/port information to UPE, to prove that UE is indeed associated with the eNB that originates the UPE path switch message 7, i.e. the eNB forwards:

path_switch_token ∥address ∥port. Here “∥” denotes concatenation.

Since the UPE, in the 3GPP architecture at the time, could be assumed to know CkUP it can verify that the path_switch_token is coming from the UE in question and by using SEQ it can verify that the message is not a replay message.

This proposal had (and still has), however, several shortcomings:
Since the token is generated at UE, it cannot be used to protect information that is later added by eNB. That is, an attacker, who is able to inject or modify packets between the eNB and the, will still be able to modify the IP address and/or port number information that UPE receives in the path switch message without this being detected. The effect is that the UPE directs the traffic to an IP address and port specified by the attacker.
The S1-U interface does necessarily provide reliable transport, i.e., packets can be lost. This implies that it is likely that acknowledge signal (ACK) has to be sent from the UPE to the eNB in response to the path switch message. It is not enough to send the path switch message multiple times to make sure that eNB has safely received it since this would trigger a replay mechanism and UPE may determine that an attack is going on. An alternative would be to generate multiple tokens at UE that is disadvantageous. A problem with using ACK is that this signal too has to be integrity protected or an attacker can stop UPE from receiving the path switch message and spoof an ACK message to the eNB. The effect of a lost path switch message would be that the UPE still sends the traffic to the source eNB, but the UE is connected to the target eNB.
The possibility of using the UP ciphering key for creation of integrity token breaks the key separation principle that stating that the same key must NOT be used both for ciphering and integrity. The key-dependency may, depending on which cryptographic functions that are used for the ciphering of UP and creation of token by use of the f function, make information available to an attacker for reducing or even compromising security for UP ciphering and/or creation of faked tokens.

It is clear that future network structure is continuously undergoing changes, e.g. as specified by 3GPP. However, certain problems generally relate to networks providing connectivity for mobile terminals. Specifically, the problem discussed above stems from the need to perform mobility related control plane signaling aiming to redirect user plane traffic in a network having (physically) separated nodes for user plane and control plane traffic, respectively. Such user plane redirection signaling will be generically referred to as path switch messages. This principle of separating user plane and control plane is a general trend fully inline with sound engineering. Therefore it is likely that future (mobile) network architectures will to a large extent adopt the same principles and consequently, such future networks are likely to encounter the same problems related to protection of the mobility related signaling.

It would thus be advantageous to have a system and method for protecting information in future networks providing mobile terminal connectivity that overcomes some/certain disadvantages of the prior art. The present invention provides such a system and method.

### BRIEF SUMMARY OF THE INVENTION

The present invention includes a plurality of access points (APs) to which a UE can connect and where the UE may change AP due to mobility, a packet core (PC) network having a control plane node (CPN) and a user plane node (UPN). Examples of such APs are: EUTRAN eNB, WLAN AP (802.11), WiMAX (802.16) Base Station, etc. The CPN provides at least for authentication and key management of the UE and the UPN provides for data connectivity to/from the UE. All traffic (both control plane and user plane data) between UE and CPN/UPN transfers via the APs. During mobility between APs, the target AP updates the CPN, by means of a path switch message, to stop forwarding UE specific data to the source AP and instead forward it to the target AP. The UE is identified by an identifier ID_UE which may change at such mobility events.

According to a first embodiment the UE provides the AP with a fresh integrity key over an already existing and secure channel for enabling AP to integrity protect information sent to the UPN.

According to a second embodiment, AP uses the key, provided for protection of the traffic between the UE and the AP, to integrity protect information provided by the UE and sent as path switch message to the UPN.

According to a third embodiment, at mobility between a source and a target AP, the target AP includes address and port information together with the new ID_UE sent (ID_UE is the new local identity to be used by the UE when communicating with the target AP) to the source AP and from there to the UE. The UE includes the address and port information in the creation of a token. The token is hence bound to the address of the target AP. Address and port typically refers to IPv4/IPV6 address and TCP or UDP port.

Thus, in one aspect, the present invention is directed to a method of protecting path switch messages in a Radio Access Network (RAN) serving mobile terminals. The method comprises the steps of: generating a first, a second, and a third (integrity) key in a User Equipment (UE); delivering, protected by the second key, the third integrity key and a sequence number in a handover confirm message to a target Access Point (AP); the AP using the third integrity key to protect a path switch message, which includes a sequence number, to a User Plane Node (UPN); the UPN using the sequence number to derive the same third integrity key for verifying the correctness and authenticity of the path switch message; and utilizing the third integrity key to confirm that the IP address and port information has not been modified and that the UE is attached to the AP that sent the path switch message. The method further comprises generating the third integrity key using a Key Derivation Function with the first key, K1, shared between UE and UPN, a sequence number in the equation

K3=KDF(K1, SEQ, . . . ).

In another aspect the present invention is directed to a method of protecting path switch messages comprising: moving a User Equipment to a target cell in a source Access Point (AP); reserving the target cell local identity in a Target AP; sending a confirmation message from the Target AP to the Source AP, the message including IP address and port information together with the target cell identity; initiating a handover command with the UE and including the IP address and port information in the handover command; the UE computing a token utilizing the IP address and port information to bind the information of the Target AP and including the token in a handover confirm message to the Target AP.

In yet another aspect, the present invention is directed to a method of protecting path switch messages, comprising: a control plane node (CPN) providing a User Plane Node (UPN) with a second key, intended for protection between UE and AP during authentication process of a User Equipment (UE); the UE sending a handover confirm message protected by the second key, including information from the Target AP and from a handover command to a Target AP; the AP using the second key to integrity protect a path switch message, the path switch message containing the information from Target AP and the handover command, to the UPN; and the UPN verifying the integrity of the path switch message.

### BRIEF DESCRIPTION OF THE SEVERAL VIEWS OF THE DRAWING

A more complete understanding of the present invention may be obtained by reference to the following detailed description when taken in conjunction with the following drawings, where:

FIG. 1 depicts a high-level schematic overview of the Long Term Evolution (LTE) radio access network (RAN);

FIG. 2 illustrates a signaling diagram of handover signaling for a UE in active mode in prior art LTE;

FIG. 3 depicts a high level signaling diagram of handover according to a first embodiment of the present invention;

FIG. 4 illustrates a high level signaling diagram of handover according to a second embodiment of the present invention; and

FIG. 5 depicts a high level signaling diagram of handover according to a third embodiment of the present invention.

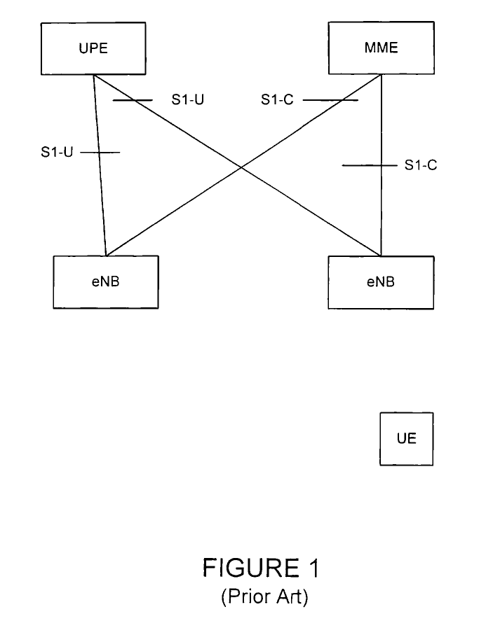

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

In general, unless explicitly noted, whenever it is stated to use a certain K to protect a certain message, protection may comprise both encryption and/or integrity protection, and usage of the key may comprise deriving further keys before actually applying them, e.g. deriving (from K) unique keys for encryption and integrity, respectively.

The following abbreviations are being used in conjunction of the description of the preferred embodiments of the present invention throughout the present description of the exemplary embodiments of the invention:

| | |
|---|---|
| ACK | ACKnowledgement message |
| AKA | Authentication and Key Agreement |
| CP | Control Plane |
| K | Key (and similarly K1, K2, . . .) |
| ID_UE | New UE local identity used by the UE when |
| | communicating with the target AP |
| AP | Access point |
| PC | Packet Core |
| UPN | User Plane Node |
| CPN | Control Plane Node |
| RAN | Radio Access Network |
| UE | User Equipment |

In the following description it is assumed that UE has authenticated towards the CPN and as result has created necessary keys. It can therefore also be assumed that the UE and an AP already have established a secure, i.e. integrity and confidentiality protected, channel between each other, using a second key K2 (from which the needed confidentiality/integrity keys can be derived).

It is further assumed that the UE can locally derive a third key, K3, in dependence of an already existing first key, K1, shared with the UPN. This is a trivial extension of the key derivations done at authentication e.g. when performing a normal AKA procedure, e.g. UMTS AKA or EAP AKA. On the network side it is assumed the CPN is responsible for key derivations and CPN derives the K1 key as well. The CPN delivers the K1 key, to the UPN. As mentioned, it is also a possible that these keys are “master keys”, which in turn can be used to derive further integrity and ciphering keys from such master keys, for simplicity we omit such discussion in the sequel.

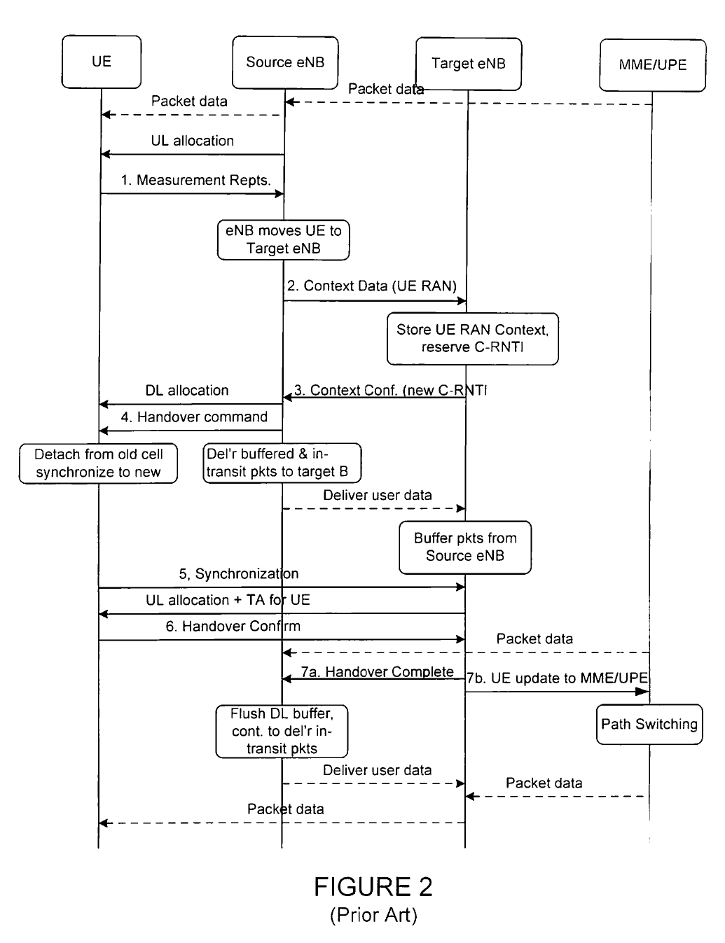

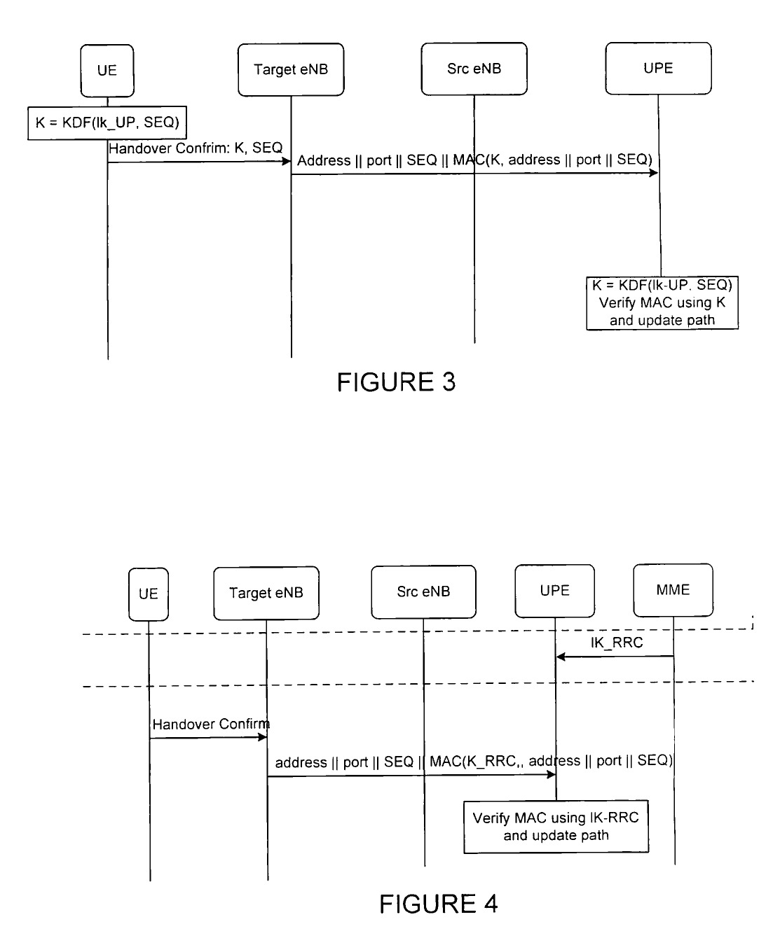

FIG. 3 depicts a high level signaling diagram of handover according to a first embodiment of the present invention. The figure only shows the relevant changes to the prior art signaling diagram shown in FIG. 2. The steps involved in the process are as follows:

1. When UE 302 is about to send the handover confirm message to the target AP, it generates a fresh integrity key K3 by applying a Key Derivation Function (KDF) with the key K1, a sequence number (or other nonce) and possibly some other data as input (e.g., UE identity). This step may also be prepared in advance.

2. UE 302 then delivers the integrity key K3 and the sequence number to target AP 304 over the secure channel protected with K2. This can suitably be done in the handover confirm message. Note that target AP 304 can verify the integrity of the key K3 due to the protection provided by K2. Target AP 304 can, assuming encryption is used, also be sure that no unauthorized 3rd party has the same key.

3. Target AP 304 uses the key K3 provided by UE to integrity protect the path switch message sent to UPN and includes the sequence number (SEQ) in the message. Note that any information that target AP 304 adds to any data originating from UE can be protected as well using the same key, i.e.,

path_switch_msg = address ∥ port ∥ SEQ ∥

<optional_other_data>

and AP then forwards
path_switch_msg ∥ MAC(K3, path_switch_msg)

to UPN 302, where K3 is the freshly generated integrity key and MAC is a Message Authentication Code. Note that the actual format of the path switch message can be different as long as at least this information is provided in the message.

4. UPN 302 can now, using the sequence number provided via target AP 304, derive (from K1) the same key K3 that UE derived in step 1 and verify the integrity of the message, implying that the IP address, port information and any other information included in the message has not been modified, and that UE 302 indeed is (or at least once was) attached to the AP originating the message.

FIG. 4 illustrates a high level signaling diagram of handover according to a second embodiment of the present invention. The figure only shows the relevant changes to the prior art signaling diagram shown in FIG. 2. The steps involved in the process are as follows:

1. During the authentication process of UE, wherein key derivations are done, CPN 408 provides UPN 404 with the K2 key (this key is also provided to the AP).

2. UE 402 sends a handover confirm message to Target AP 402

3. Target AP 404 uses the K2 key to integrity protect the path switch message, containing the information from Target AP 404 and possible information from the handover command from UE 402, to UPN 406. That is, the key K2, normally used only between UE 402 and Target AP 404, are, according to this embodiment, re-used also between Target AP 404 and UPN 406.

4. UPN 406 can now verify integrity of the path switch message.

It is good cryptographic practice to ensure that it is not possible to capture messages between UE and AP and later replay these to UPN as if they where sent from AP and vice versa. Since the same key (K2) is used on both links this could, in theory, be possible. A trivial way to avoid this problem is that one bit is input to the integrity algorithm to indicate if the message is intended to go between UE and AP or between AP and UPN, E.g. the sequence numbers used for replay protection on both links can then easily be considered to belong to separate number spaces.

As described above the interface between AP and UPN does not necessarily provide a reliable transport and it is likely that the path switch message requires an ACK from Packet Core Network (PC) back to AP. By the above described processes, AP and PC will share a symmetric key that is used for (integrity) protection of the path switch message. This key can also be used “in the other direction”, from PC to AP, to integrity protect an ACK message and additional data such as a sequence number for replay protection and an ID associated with the path switch message that it corresponds to.

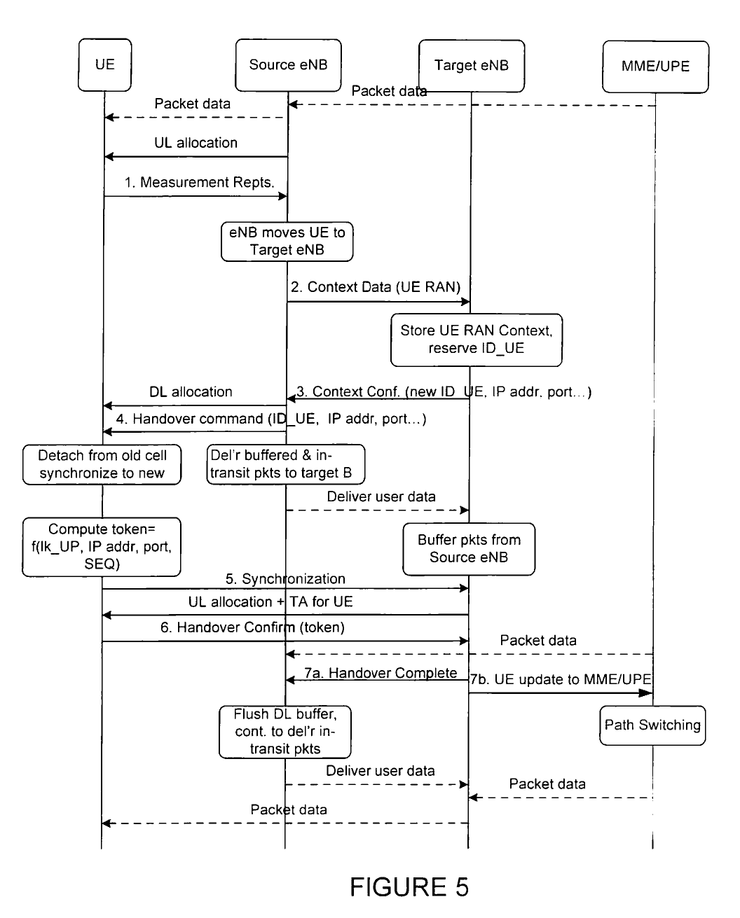

FIG. 5 depicts a high level signaling diagram of handover according to a third embodiment of the present invention:

1. Target AP 506 includes address and port, allocated for reception of data from UE 502, in the message providing Source AP 504 and ID_UE.

2. Source AP 504 sends, over the connection that is (integrity and confidentiality) protected using K2, the address port information to UE 502 together with ID_U E.

3. UE 502 includes the address and port information in the creation of a token thereby binding the information that Target AP 504 sends to UPN 508.

4. UE 502 sends the token to Target AP 504 in a handover confirm message.

5. Target AP 504 includes the token in the path switch message sent to UPN 508, which can verify the integrity of the token, and can rest assured that the address of Target AP 504 is the correct one.

A clear distinction is noticed between the identity of an AP as used in the prior art solution and the address of AP as used in the third embodiment.

The identity, e.g. a name, is not what the token is required to protect, but rather the address, i.e., the information that AP actually sends to UPN. It is not sufficient to protect the identity since it is possible that the address space is renumbered in the RAN but the identities of an AP would remain the same.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

### REFERENCE

[1] “UMTS Evolution from 3GPP Release 7 to Release 8 HSPA and SAE/LTE”, Jul. 7, 2007 www.3gamericas.com.
[2] S3-060455 “Security of S1-U”; Mr. Dajiang Zhang; NOKIA Corp.;“2006-07-04;”6.26 SAE/LTE security”;

What is claimed:

1. A method of protecting path switch messages between a UE and a Network, the method comprising:
generating a key in a User Equipment;
delivering the key and a sequence number in a handover confirm message to a target AP (AP):
the AP using the key to at least integrity protect a path switch message, which includes the sequence number, to a UPN:
the UPN using the sequence number to derive the same key for verifying the integrity of the path switch message; and
utilizing the same key to confirm that the IP address and port information has not been modified and that the UE is attached to the AP that sent the path switch message.

2. The method of claim 1, the key being generated using a Key Derivation Function (KDF) with a first Key (K1) shared with the UPN, and a sequence number (SEQ) provided by the equation
K=KDF(K1, SEQ, . . . ).

3. The method of claim 2 wherein delivery of the key is protected using a second key (K2) shared between the UE and the AP.

4. The method of claim 3 wherein said first and second key are produced as a result of authentication and key agreement (AKA) between the UE and a control plane node (CPN).

5. The method of claim 4 wherein said AKA is based on UMTS AKA.

6. In a Network, a method of protecting path switch messages comprising:
moving a User Equipment (UE) to a target cell from a source Access Point (AP);
reserving the target cell local identity in a Target AP;
sending a confirmation message from the Target AP to the Source AP, the message including address and port information together with the target cell identity;
initiating a handover command with the UE and including the address and port information in the handover command;
the UE computing a token utilizing the address and port information to bind the information of the Target AP; and
including the token in a handover confirm message to the Target AP.

7. In a Network, a method of protecting path switch messages, comprising:
a control plane node (CPN) providing a User Plane Node (UPN) with a second Radio Access Network (RAN) key as well as first User Plane key during authentication process of a User Equipment (UE);
the UE sending a handover confirm message, including information from the Target AP and from a handover command to a Target AP;
using the RAN key to at least integrity protect a path switch message, the path switch message containing the information from the Target AP and the handover command, to the User Plane Node; and
the User Plane Node verifying the integrity of the path switch message.

8. An access node in a Radio Access Network (RAN) providing for mobility of a User Equipment (UE) during handover from another access node, the access node comprising:
means for receiving a handover confirm message from the UE, the handover confirm message comprising at least a Radio Access Network key and a sequence number;
means for forming a path switch message that is integrity protected by said key, the message including at least the sequence number and address information at which the node will receive data originating from the UE;
means for sending the message to a User Plane Node to complete the handover.

9. The access node according to claim 7, further comprising means for forming a token that is included in the path switch message.

10. The access node according to claim 8, wherein the token is received in the handover confirm message.

11. The access node according to claim 7, wherein said means for forming further comprises means for including concatenation of said access node address information and corresponding address information of said another access node to authenticate the handover by the UE.
